(19) United States
(12) Patent Application Publication
(10) Pub. No.: US 2012/0225578 A1
(43) Pub. Date: Sep. 6, 2012

(54) Electrical connection, cord anchor and method of anchoring same

(76) Inventor: Thomas F. Adams, Fort Myers, FL (US)

(21) Appl. No.: 13/385,508

(22) Filed: Feb. 23, 2012

Related U.S. Application Data
(60) Provisional application No. 61/464,174, filed on Mar. 1, 2011.

(51) Int. Cl. H01R 13/62; H01R 43/00

(52) U.S. Cl. 439/373; 29/825

(57) ABSTRACT

A cord anchor device is used in conjunction with an electrical cord itself to prevent an electrical plug from becoming dislodged from an electrical socket of an electrical outlet assembly. Several embodiments and attachment methods are disclosed including methods where the electrical cord may be attached by “looping and threading” the electrical cord through the cord anchor device.

The benefit of U.S. Provisional Patent Application Ser. No. 61/464,174 filed Mar. 1, 2011 is claimed.

Today, many people use electrical appliances for a wide variety of reasons. To connect electrical appliances to a source of power, electrical cords typically run directly from the appliance to an electrical outlet where an electrical male plug at the end of the electrical cord is plugged into a female socket of the electrical outlet. When using these electrical appliances, whether indoors or outdoors, there can be a great amount of tension on the electrical cord, which causes the electrical plug to dislodge from the electrical socket and move away from the outlet. This is an all too common problem with electrical devices such as vacuum cleaners, portable saws, hedge clippers, and power lawn mowers. When the electrical plug pulls out of the electrical socket, it can be frustrating, as well as a major inconvenience because the work stops. In order to plug the electrical plug back into the electrical outlet, the person using the appliance must walk back the full length of the electrical cord, wasting time and effort.

There have been many attempts to create a device that prevents the electrical plug from being dislodged. However, many of those devices are only for a single appliance and require complete disassembly when switching from one appliance to another. For example, U.S. Pat. No. 4,768,974, issued to Cowan on Sep. 6, 1988, provides a strap which is attached to a cord of an appliance. This strap has a hook, which is used to anchor the cord to an eyelet attached to an outlet. To retain the electrical connection of a different appliance, the strap must be removed from the cord of one appliance, and then attached to the cord of another appliance. Alternatively, multiple straps could be purchased and attached to various appliances. However, this increases cost and introduces handling problems.

For the forgoing reasons, there is a need for a cord anchor and anchoring method that is simple and easy to use and does not require straps or the like to prevent an electric plug from being dislodged from an electrical connection.

### SUMMARY OF THE INVENTION

This invention provides an electrical connection, an electrical outlet assembly, and/or a cord anchor that prevents the dislodgement of an electrical plug from an electrical socket.

This invention also provides a method for anchoring an electrical cord to prevent dislodgement of an electrical plug from an electrical socket.

In one aspect, the invention provides an inexpensive, easy to install cord anchor for preventing an electrical plug from inadvertently dislodging from an electrical socket.

Accordingly, the present invention provides a cord anchor that works with the electrical cord itself, allowing for use without additional cord preparation. The cord anchor reduces the tension applied to the electrical cord at the connection to the electrical outlet. The tension at least in part is diverted to the cord anchor, thus keeping the electrical connection intact. The cord anchor is simple, easy to use, and does not require any preparation of the cord. The cord anchor also preferably has rotatable parts so that the cord anchor can be configured substantially flat when not in use or when being shipped.

In another aspect, the invention provides a method of anchoring an electric cord which relies on the cord anchor or and/or the electrical connector at the end of the electric cord without any need for any auxiliary device such as a strap or the like.

### BRIEF DESCRIPTION OF THE DRAWINGS

FIG. 1 is an exploded, partially sectioned front view of an electrical outlet assembly illustrating a preferred embodiment of the invention;

FIG. 2 is a front view of the electrical outlet assembly illustrated in FIG. 1 with the face plate removed and showing the cord anchoring device attached;

FIG. 3 is a section view taken substantially along line 3-3 of FIG. 2 looking in the direction of the arrows and showing the electrical outlet assembly installed in a wall;

FIG. 4 is a section view taken substantially along line 4-4 of FIG. 2 looking in the direction of the arrows and showing the electrical outlet assembly installed in a wall;

FIG. 5 is an enlarged view of a portion of the section of the electrical outlet assembly shown at 5 in FIG. 4;

FIG. 6 is a front view of a cord anchor which is part of the electrical outlet assembly illustrated in FIG. 1;

FIG. 7 is a front view of the electrical outlet assembly illustrated in FIG. 1 and an electrical cord in the process of being anchored to the electrical outlet assembly;

FIG. 8 is a front view of the electrical outlet assembly illustrated in FIG. 1 with the electrical cord anchored and connected to the electrical outlet assembly;

FIG. 9 is a partially sectioned front view of a modified electrical outlet assembly illustrating another preferred embodiment of the invention;

FIG. 10 is a side view of the modified electrical outlet assembly shown in FIG. 9;

FIG. 10A is a section taken substantially along the line 10A-10A of FIG. 9 looking in the direction of the arrows.

FIG. 11 is a front view of the electrical outlet assembly shown in FIG. 9 illustrating an electrical cord attached to the electrical outlet assembly in a different manner;

FIG. 11A is a side view of the electrical outlet assembly and electrical cord shown in FIG. 11;

FIG. 12 is a perspective front view of another modified electrical assembly illustrating another preferred embodiment of the invention;

FIG. 12A is a front view of another modified electrical outlet assembly illustrating another preferred embodiment of the invention;

FIG. 12B is a rear perspective view of a component that is part of the electrical outlet assembly shown in FIG. 12A;

FIG. 13 is a front view of yet another modified electrical outlet assembly illustrating another preferred embodiment of the invention;

FIG. 14 is a front view of the modified electrical outlet assembly of FIG. 13 showing an electrical cord attached,

FIG. 15 is an enlarged view of a component of the modified electrical assembly shown in FIGS. 13 and 14.

FIG. 16 is a front view of still yet another modified electrical outlet assembly illustrating still another preferred embodiment of the invention;

FIG. 17 is a front view of the modified electrical outlet assembly of FIG. 16 showing an electrical cord attached to the electrical outlet assembly.

FIG. 18 is a front view an electrical outlet assembly illustrating another preferred embodiment of the invention;

FIG. 19 is a section taken substantially along the line 19-19 of FIG. 18 and looking in the direction of the arrows to show details of a cord anchor which is part of the electrical outlet assembly illustrated in FIG. 18;

FIG. 20 is a section taken substantially along the line 20-20 of FIG. 18 looking in the direction of the arrows to show details of the cord anchor which is illustrated in FIGS. 18 and 19.

FIG. 21 is a front view of another electrical outlet assembly illustrating another preferred embodiment of the invention equipped with the cord anchor shown in FIGS. 19 and 20.

FIG. 22 is a front view an outdoor electrical outlet assembly illustrating still yet another preferred embodiment of the invention;

FIG. 23 is a front view of the outdoor electrical outlet assembly illustrated in FIG. 22 and an electrical cord in the process of being anchored to the outdoor electrical outlet assembly;

FIG. 24 is a front view of the outdoor electrical outlet assembly illustrated in FIG. 22 with the electrical cord anchored and connected to the electrical outlet assembly;

FIG. 25 is a side view of the outdoor electrical outlet assembly illustrated in FIG. 24. FIG. 25a is an enlargement of a portion of FIG. 25.

FIG. 26 is a front view of another embodiment of a cord anchor of the invention for the outdoor electrical outlet assembly shown in FIGS. 22, 23, 24 and 25;

FIG. 27 is a side view of the cord anchor shown in FIG. 26 and;

FIG. 28 is a bottom view of the cord anchor shown in FIGS. 26 and 27.

### DETAILED DESCRIPTION OF PREFERRED EMBODIMENTS

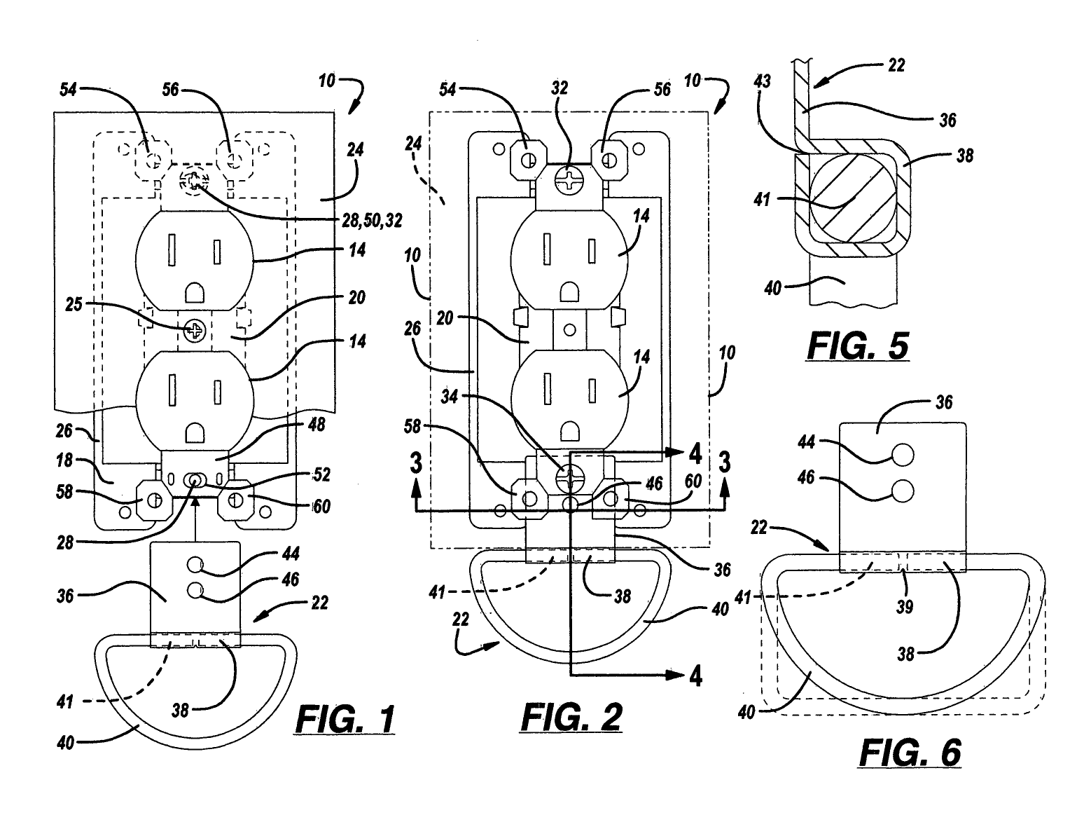

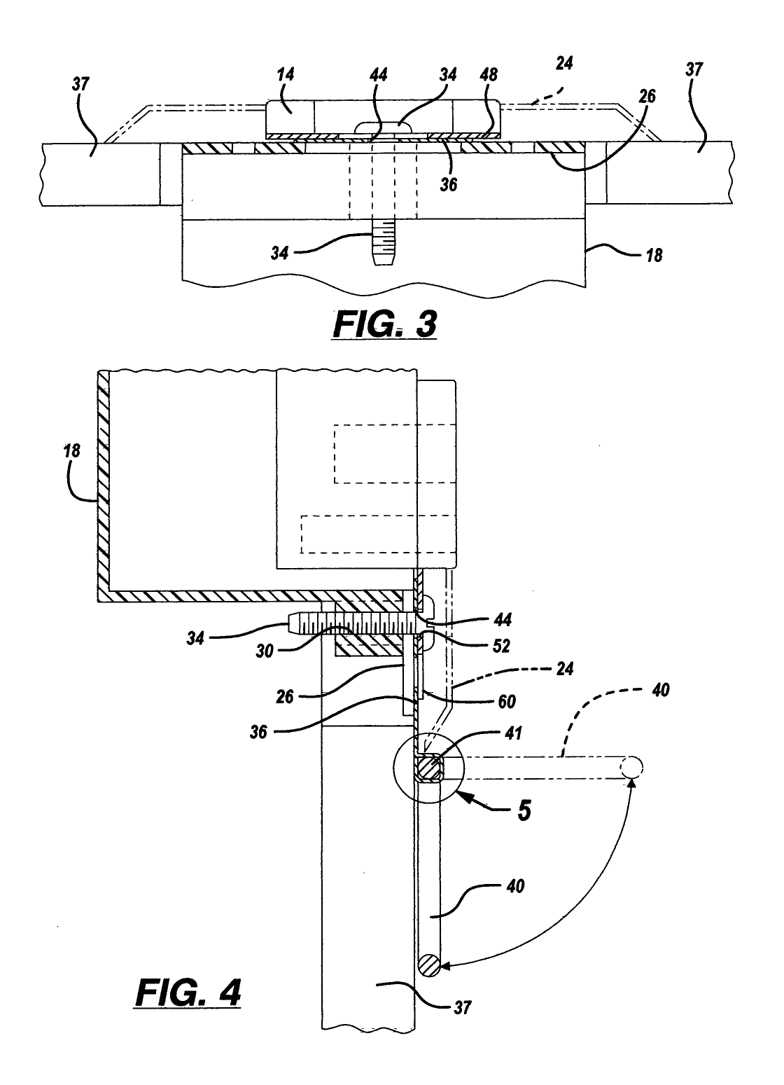

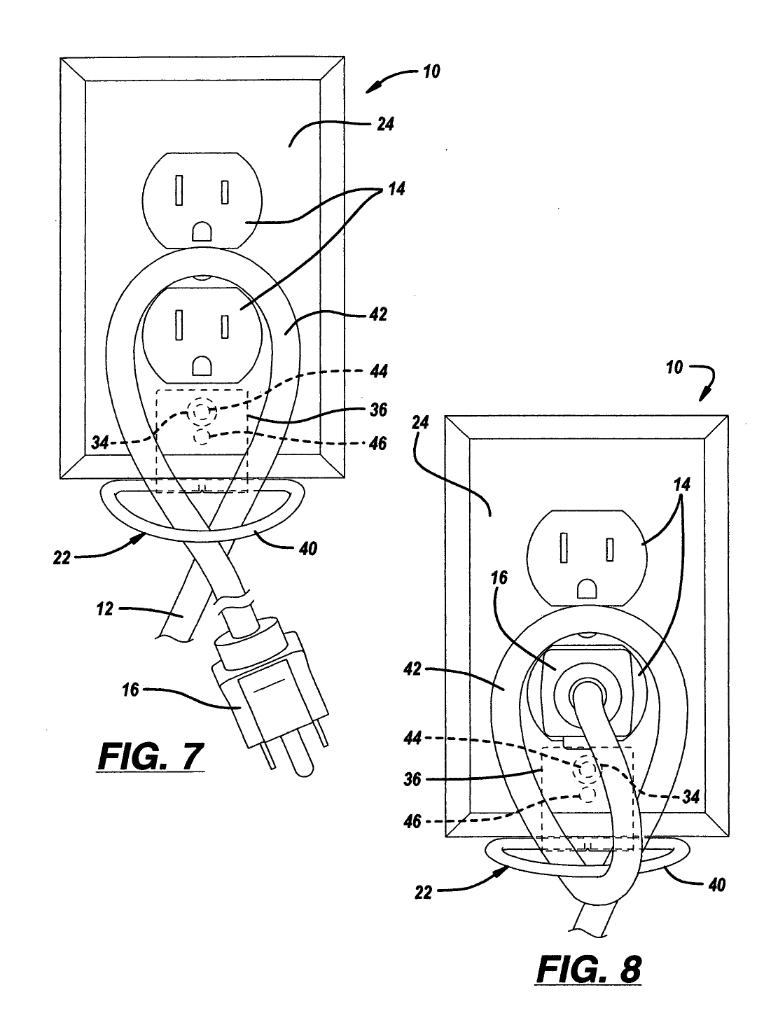

An electrical outlet assembly 10 illustrating a preferred embodiment of the invention is shown in FIG. 1, FIG. 2, FIG. 3, FIG. 4, FIG. 5, FIG. 6, FIG. 7 and FIG. 8.

The electrical outlet assembly 10 comprises an electrical box 18, an electrical socket assembly 20, a face plate 24, an electrical cord 12 and a cord anchor 22. The electrical box 18 has an opening that is defined by a rim 26.

The electrical socket assembly 20 comprises two electrical sockets 14 and a metal strap 48 that passes through the electrical sockets 14 and spans the opening of the electrical box 18. The metal strap 48 has two ends, each with an oval-shaped hole 50, 52, that are positioned above two round holes in the rim 26 of the electrical box 18, to attach the electrical sockets 14 to the electrical box 18 by fasteners such as screws 32, 34. The metal strap 48 also has four ears 54, 56, 58, 60, which protrude from the four corners of the metal strap 48 respectively.

The cord anchor 22 comprises a flat base 36 and an anchor ring 40. The flat base 36 has an attachment hole 46 and a clearance hole 44. The flat base 36 has an anchor collar 38 at one end that may be formed by bending an end portion of the flat base 36 to form a square or round anchor collar 38 around a round pin portion 41 of the anchor ring 40 as best shown in FIG. 5. The anchor ring 40 is usually a D shaped ring although other shapes may be used. In any event, the anchor ring 40 preferably has a round pin portion 41 that rotates in the anchor collar 38 so that the anchor ring 40 is moveable from a storage position parallel to the flat base 36 (as shown in solid line in FIG. 4) to an angular position with respect to the flat base 36 (as shown in phantom line in FIG. 4). The angular position is the operative position of the anchor ring 40. The preferred operative position for anchoring the electrical cord 12 is easily provided when the anchor ring 40 is perpendicular to the flat base 36. Ideally, the flat base 36 of the cord anchor 22 is completely flat (except for the anchor collar 38) so that the flat base 36 and the cord anchor 22 lie substantially flat against wall 37 when the electrical outlet assembly 10 is installed in a conventional manner and the anchor ring 40 is in the storage position parallel to the flat base 36. It should be noted that the anchor collar 38 at the bottom end of the anchor base 36 is preferably bent in a clockwise manner as viewed in FIG. 5 so that the seam 43 is isolated from the face plate 24 and the seam 43 itself is shielded thus protecting both the electrical outlet assembly 10 and the anchor collar 38 against ingress of water and other deleterious material.

FIGS. 2, 3 and 4 show the cord anchor 22 attached to the electrical socket assembly 20 by fastener 34 which passes through the hole 52 in strap 48 and through the attachment hole 46 of the cord anchor 22 and screws into the round hole 55 in the rim 26 of the electrical box 18.

The cord anchor 22 is easily attached to the electrical socket assembly 20 simply by removing the face plate 24 (which is held by a single central fastener 25 screwed into the metal strap 48) and then removing the fastener 34 which holds the lower end of the metal strap 48 to the electrical box 18. The flat base 36 of the cord anchor 22 is then placed between the lower end of the metal strap 48 and the rim 26 of the electrical box 18. The oval shaped hole 52 of the metal strap 48, the attachment hole 46 of the cord anchor 22 and the round hole in the rim 26 of the electrical box 18 are then aligned. The fastener 34 is then inserted through the oval shaped hole 52 and the attachment hole 46 and then screwed into the round hole 55 of the rim 26 to secure the metal strap 48 and the flat base 36 of the cord anchor 22 to the rim 26 of the electrical box 18. The face plate 24 is then reattached by the single fastener 25.

FIG. 3 shows the electrical outlet assembly 10 installed in a wall 37 with the cord anchor 22 attached to the installed electrical outlet assembly 10. The flat base 36 of the cord anchor 22 easily fits tightly between the metal strap 48 of the electrical socket assembly 20 and the rim 26 of the electrical box 18. This provides a secure attachment for immovably holding the flat base 36 of the cord anchor 22 against the wall 37.

FIG. 4 shows that the anchor ring 40 of the cord anchor 22 is rotatable when the cord anchor 22 is attached to the installed electrical outlet assembly 10. This feature allows movement of the anchor ring 40 from a storage position to an operative position. In the storage position, the anchor ring 40 is substantially parallel to the flat base 36 for ease in shipping the cord anchor 22 itself. Moreover, the in the storage position, the anchor ring 40 is substantially coplanar with the face plate 24 for ease in storage substantially flat against the wall 37 when the cord anchor 22 is not being used.

FIG. 6 shows the cord anchor 22 in detail . . . . The flat base 36 has a clearance hole 44 and an attachment hole 46. The anchor ring 40 can be a variety of shapes, but it is typically a D-shaped as shown in solid line or rectangular shaped as shown in dashed line. The anchor ring 40 may be wider than shown and may be made of metal, plastic or other materials. The anchor ring 40 may be centered in the anchor collar 38 in various ways. For instance, the anchor collar 38 may have a dimple 39 that fits between the ends of a formed D-shaped anchor ring 40 as shown in FIG. 6 or in a recess in an endless anchor ring (not shown).

The electrical cord 12 is anchored and plugged into the electrical outlet assembly 10 to make a secure electrical connection by a “looping and threading” method. If in a stored position against the wall 37, the anchor ring 40 is rotated to an operative position away from the wall 37 where the anchor ring 40 is at substantial angle (and ideally perpendicular) with respect to the wall 37 as shown in FIG. 4. A plug end portion of the electrical cord 12 is then simply looped, i.e. formed into a loop 42 and the loop 42 is then threaded through the anchor ring 40 and positioned so that the loop 42 of the electrical cord 12 aligns with one of the electrical sockets 14 while the electric plug 16 remains spaced outwardly of the anchor ring 40 away from the electrical socket 14 as shown in FIG. 7. The electrical plug 16 is then brought over the anchor ring 40, inserted through the loop 42 of the electrical cord 12 and plugged into the lower one of the electrical sockets 14 thus anchoring the electrical cord 12 and electrical plug 16 in place as shown in FIG. 8. It should be noted that the loop 42 is wrapped around electrical plug 16 (and kept wrapped around the electrical plug 16 by the anchor ring 40) so that any pull on the electrical cord 12 from the opposite end of the electrical cord 12 applies a lateral force to the electrical plug 16. The electrical plug 16 thus resists a considerably higher pull out force from the electric cord 12 than a pull out force that would be applied in an axial direction in a conventional installation.

As noted above, the primary function of the anchor ring 40 is to hold the loop 42 wrapped around the electrical plug 16. Thus the tension on electrical cord 12 normally does not apply any great force to the anchor ring 40. However, if an excessive force is applied to the anchor ring 40 of the cord anchor 22 the anchor collar 38 simply unbends allowing the anchor ring 40 to separate from the cord anchor 22 freeing electric cord 12. This optional fail safe feature of this particular embodiment prevents the entire electrical outlet assembly 10 being ripped out and causing any damage to the wall 37 in the event that an excessive force is applied to the electrical cord 12 and to the cord anchor 22 via the anchor ring 40.

The anchor ring 40 is preferably large enough to provide enough space for a plug end portion of a second electrical cord (not shown) to be looped and inserted through the anchor ring 40 so that the plug of the second cord can also be plugged into the upper one of the electrical sockets 14 by a looping and threading method.

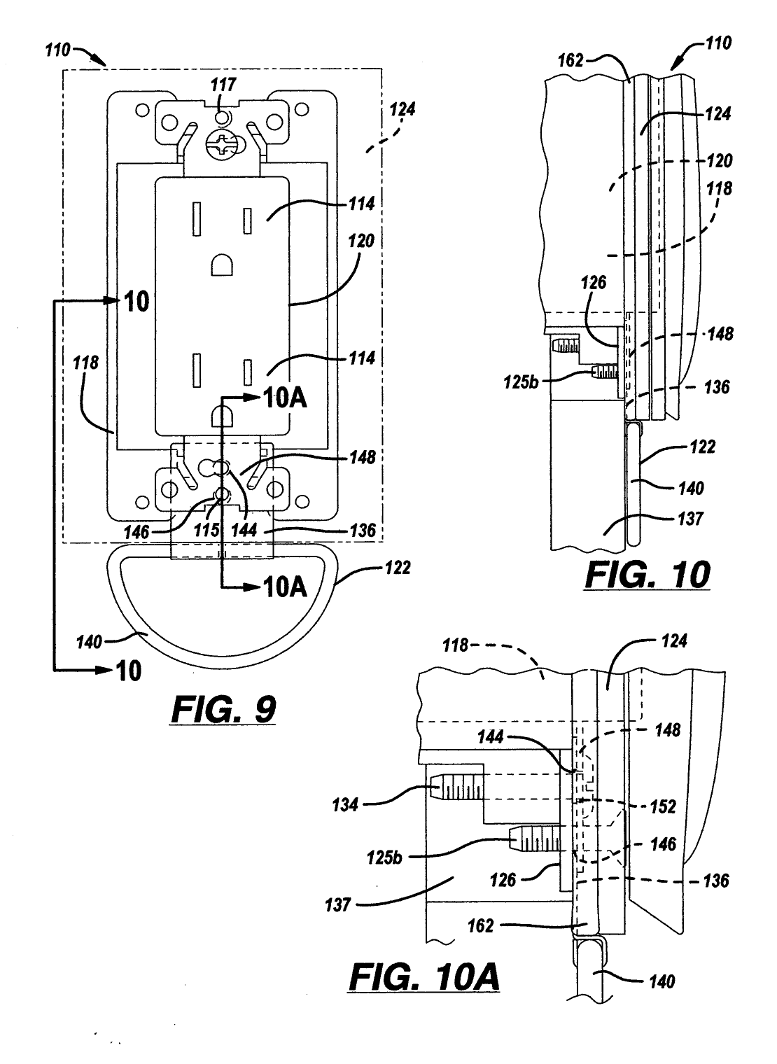

A second preferred embodiment is shown in FIG. 9 and FIG. 10 in an electrical outlet assembly 110. In this embodiment, the electrical socket assembly 120 is slightly different than electrical socket assembly 20 but the other components of the electrical outlet are substantially the same and identified by adding 100 to the identifying numerals for the components in the first embodiment. The electrical socket assembly 120 of this second embodiment has two electrical sockets 114 embedded in a single plastic unit and a modified metal strap 148 that has two end holes 115 and 117 for attaching a suitably modified face plate 124 as shown in FIG. 9 and FIG. 10. This configuration is popular of both interior and exterior outlets.

The cord anchor 122 is identical to the cord anchor 22 and it is installed in the same manner. The flat base 136 of the cord anchor 122 like the flat base 36 of the cord anchor 22 has a clearance hole 144 and an attachment hole 146. The attachment hole 146 is used to attach the cord anchor 122 to the electrical box 118 in the same manner that the attachment hole 46 is used to attach the cord anchor 22 to the electrical box 18. However, the modified face plate 124 is attached by upper and lower fasteners 125a and 125b instead of a single central fastener 25. When the face plate 124 is attached after the cord anchor 122 is installed, the clearance hole 144 provides clearance for the lower fastener 125b to secure the face plate 124 against the wall 137 as shown in FIG. 10. Thus the clearance hole 144 provides versatility in that the identical cord anchors 22 or 122 can be used with either electrical socket assembly 20 or socket assembly 120, both of which are popular today. For exterior outlets, a sealing gasket 162 is customarily placed between the face plate 124 and the rim 126 of the electrical box 118 to keep water out of the electrical outlet assembly 110. For such applications, the flat base 136 can be made quite thin so that the base 136 does not interfere with the effectiveness of the sealing gasket. For instance, the flat base 136 of the cord anchor 122 may be made of steel or aluminum which is about 0.020 inches thick. This possibility adds to the versatility of the identical cord anchors 22 and 122.

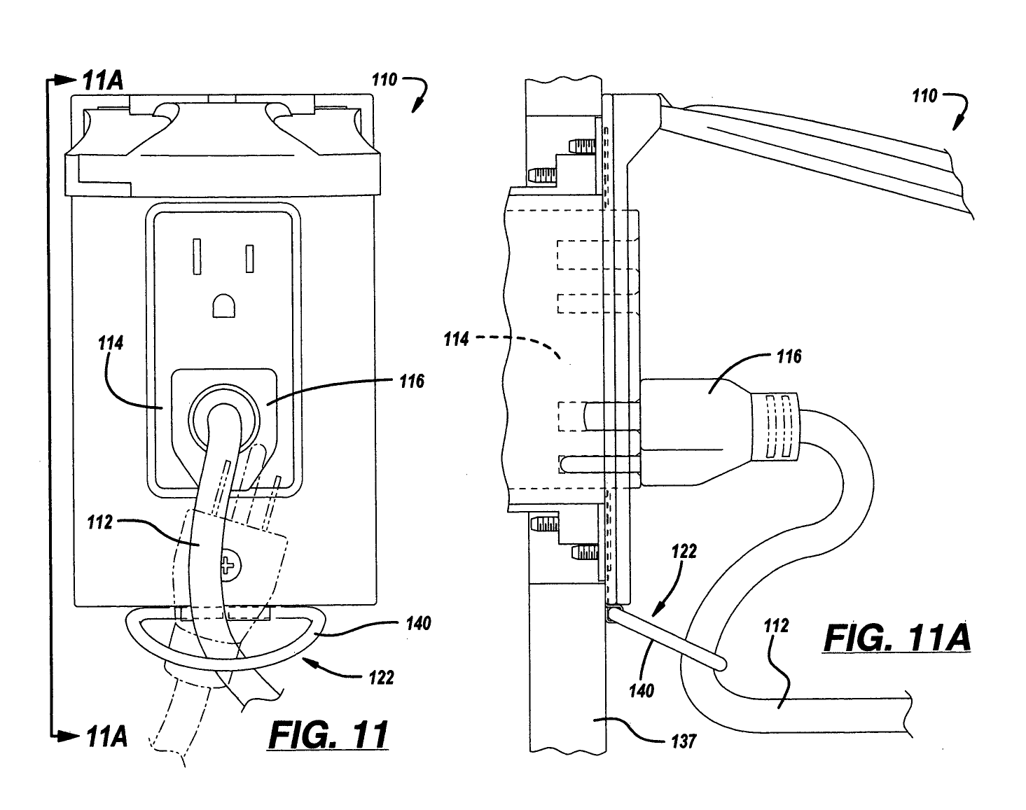

It is also possible that an electrical plug 116 may be small enough to fit through the anchor ring 140 in which case, the end portion of an electrical cord 112 attached to the electrical plug 116 need not be looped. In this instance, the electrical plug 116 and end portion of the electrical cord 112 is simply threaded through the anchor ring 140 and the electrical plug 116 is simply plugged into one of the electrical sockets 114 as shown in FIGS. 11 and 11A. Thus any pull on the electrical cord 112 results primarily in a lateral force rather than an axial pull-out force being applied to the electrical plug 112. In fact, pull on the electrical cord 112 may be diverted through anchor ring 140 and may even result in an axial force tending to push the electrical plug 116 into the socket 114. See FIG. 11A particularly. This method of threading an electrical plug and end portion of an electrical cord through anchor ring will also work with the anchor ring 40 provided the plug 16 is small enough to fit through anchor ring 40. This threading and plugging method, however, while advantageous may not be as desirable or effective as the above-mentioned “looping and threading” method.

It is also possible for a cord anchor 122A to have a fixed or non-rotatable anchor ring 140A which can be a complete anchor ring or a part attached to another component to form an anchor ring such as a bail 142A non-rotatably secured to a face plate 124A as shown in FIG. 12. In this particular instance, the anchor ring 140 is secured to the longer side of the face plate which may be an advantage when a plug is plugged in each electrical socket and anchored. Such fixed anchor rings may be just as effective as rotatable anchor rings for anchoring an electric cord with either the threading and looping method or the threading and plugging method described above. However, a fixed anchor ring does not have the shipping and storage advantages of the cord anchors 22 and 122 (shown in FIGS. 1-11A) which not only provide these shipping and storage advantages but which also have the financial and ecological advantages of being marketed as a low cost add-on to existing electrical outlet assemblies.

It is also possible for a cord anchor 122B to have a hybrid anchor ring 140B having a rotatable bail 142B attached to another component to form the anchor ring 140B, such the bail 142B which is rotatably secured to a face plate 124B as shown in FIGS. 12A and 12B. Such hybrid anchor rings may be just as effective as rotatable anchor rings for anchoring an electric cord with either the threading and looping method or the threading and plugging method described above. Moreover, the hybrid anchor ring does have the shipping and storage advantages of the cord anchors 22 and 122 (shown in FIGS. 1-11A) which not only provide these shipping and storage advantages but which also have the financial and ecological advantages of being marketed as a low cost add-on to existing electrical outlet assemblies.

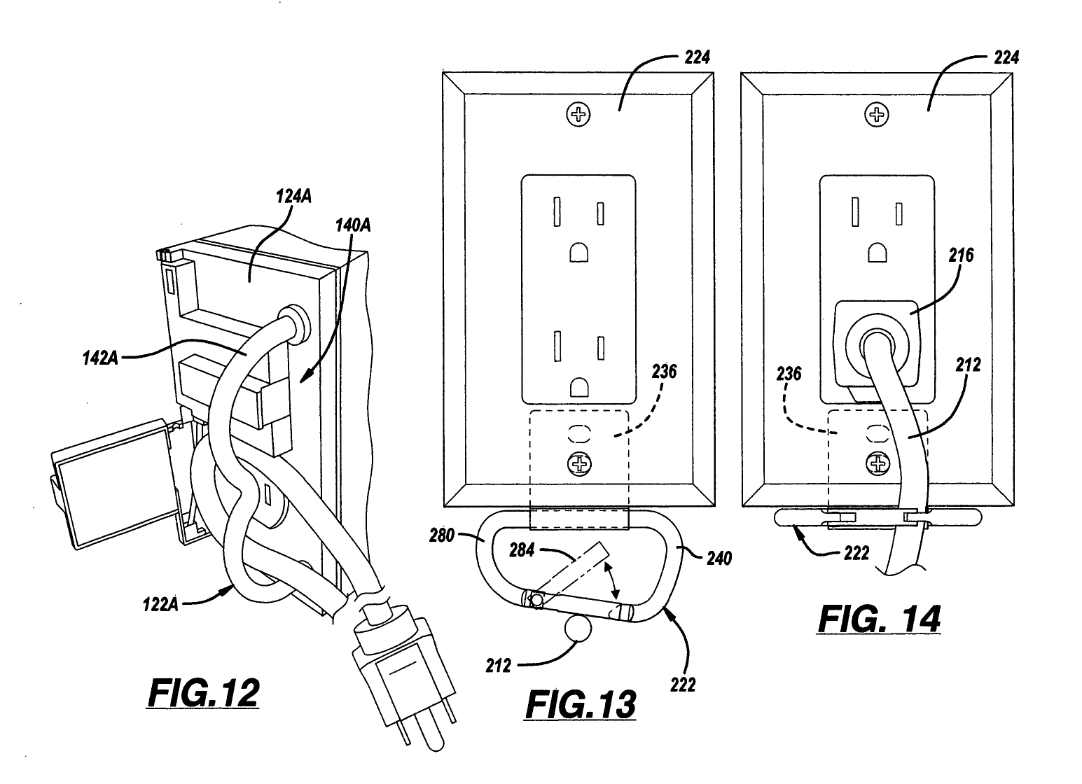

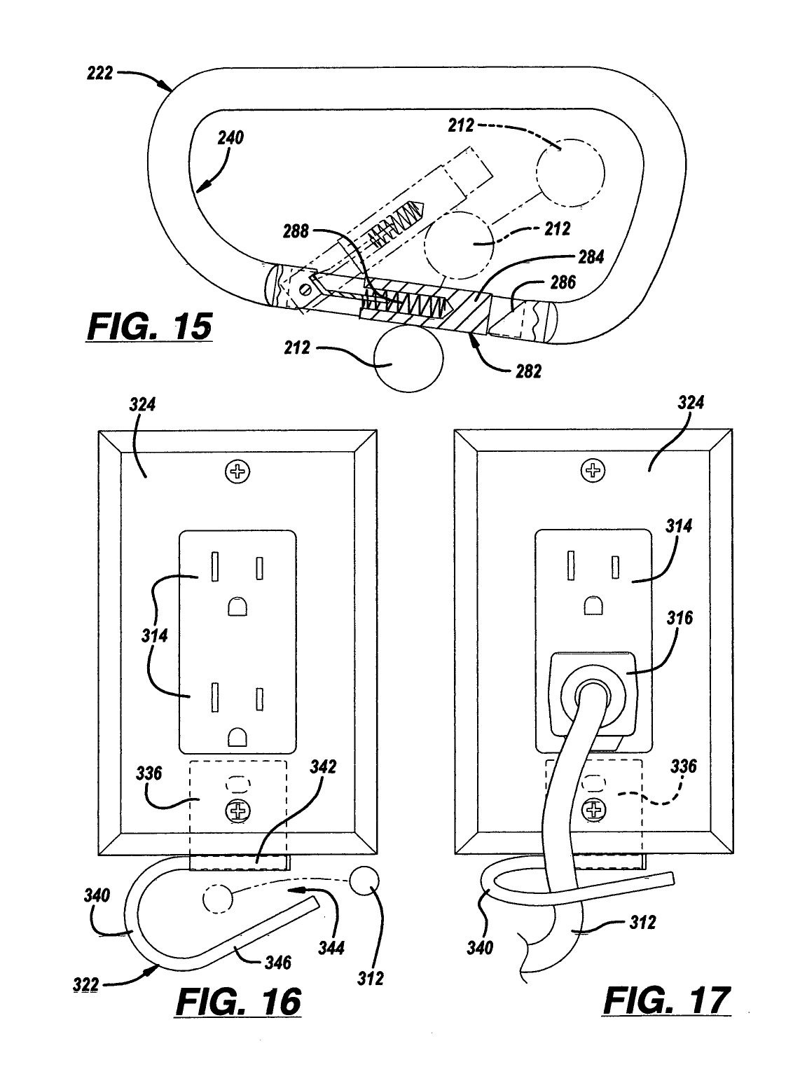

Another embodiment of the invention is shown in FIGS. 13, 14 and 15. In this embodiment, the cord anchor 222 has a gated anchor ring 240 instead of the ungated anchor rings 40 and 140 of the embodiments described above. However, the cord anchor 222 is otherwise the same as cord anchor 22 or cord anchor 122 and it is attached the same way. Like parts are identified with a 200 series of corresponding numbers. The gated anchor ring 240 accommodates a simplified method of anchoring and mating an electrical connector similar to that described in connection with FIGS. 11 and 11A. However, an advantage of the gated anchor ring 240 is that it does not restrict the size of the electrical connector 216 that is attached to the electrical cord 212 as in the case of the anchor ring 140 described in connection with FIGS. 11 and 11A. The gated anchor ring 240 comprises a partial ring 280 that defines an opening 282 that is closed by a moveable gate 284. Gate 284 is pivotally attached to the partial ring 280 at one end and biased against a stop 286 at the opposite end by a spring 288 so that gate is moveable from a closed position shown in solid line in FIGS. 13 and 15 to an open position shown in phantom. To make an electrical connection, the end portion of the electrical cord 212 is simply pushed laterally against the gate 284 opening the gate 284 and admitting a portion near the plug end of the electrical cord 212 inside the anchor ring 240. The gate 284 then snaps shut under the bias of spring 288. The electrical plug 216 is then simply plugged into the one of the electrical sockets 214, for instance the lower one as shown in FIG. 14.

The gated anchor ring 240 may be rotatably attached to a base 236 as in the case of cord anchors 12 and 112. Alternatively, the gated anchor ring 240 can be attached directly to another component, such as the face plate 224 with the attachment being either rotatable or non-rotatable.

A still further embodiment of the invention is shown in FIGS. 16 and 17. In this embodiment, the anchor ring of the cord anchor 322 is replaced by a hook 340 that has one leg 342 rotatably attached to a base 336 and an opening 344 that is defined by the attached leg 342 and a second leg 346. In this embodiment, an end portion of the electrical cord 312 that is attached to the electrical plug 316 is simply inserted laterally into the hook 340 through the opening 344 opening as shown in FIG. 16. The electrical plug 316 is then simply plugged into the one of the electrical sockets 314 as shown in FIG. 17. Thus cord anchor 322 with the hook 344 also accommodates a simplified method of anchoring and mating an electrical connector similar to that described in connection with FIGS. 11 and 11A. An advantage of the cord anchor 322 with the hook 340 like that of the cord anchor 222 with gated anchor ring 240 is that the cord anchor 322 also does not restrict the size of the electrical connector plug 316 as in the case of the embodiment described in connection with FIGS. 11 and 11A.

The hook 340 may be rotatably attached to a base 336 as in the case of cord anchors 12 and 112. Alternatively, the hook 340 can be attached directly to another component, such as the face plate 324 with the attachment being either rotatable or non-rotatable. In any event, the hook 340 is preferably horse shoe shaped to reduce the size of the opening 344 and provide an arched second leg 346 that improves retention of the electrical cord in the hook 340.

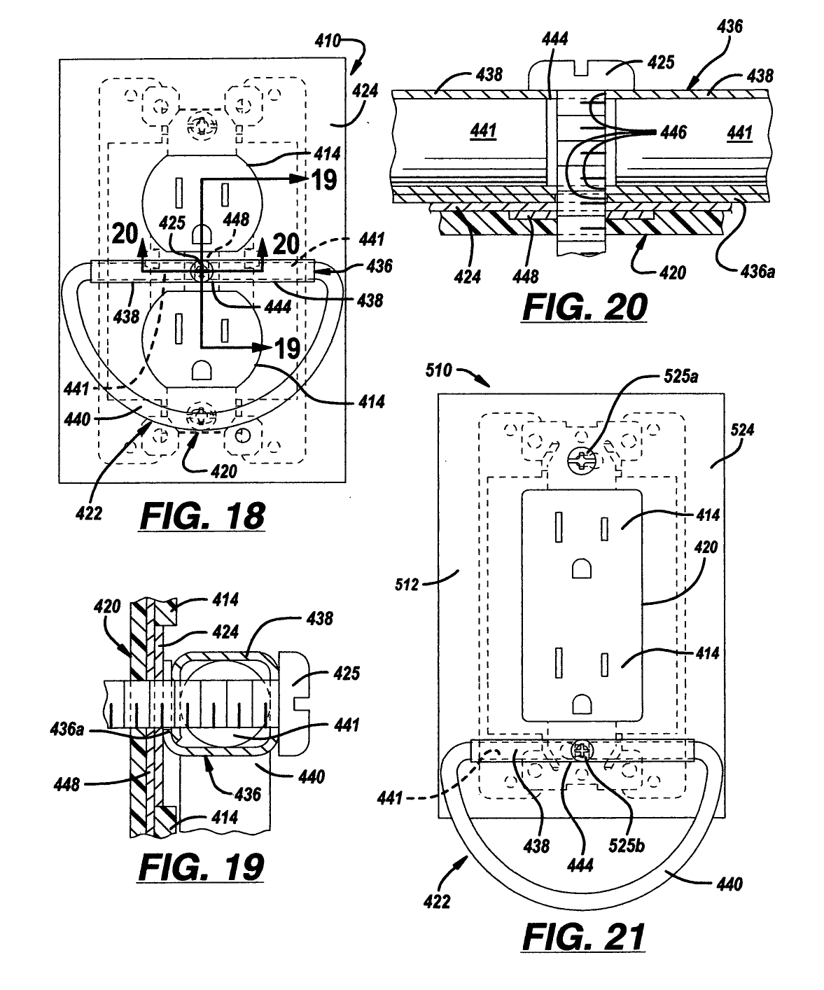

FIG. 18 is a front view an electrical outlet assembly 410 illustrating another preferred embodiment of the invention; FIG. 19 is a section taken substantially along the line 19-19 of FIG. 18 and looking in the direction of the arrows to show details of a cord anchor 422 which is part of the electrical outlet assembly 400 illustrated in FIG. 18; and FIG. 20 is a section taken substantially along the line 20-20 of FIG. 18 looking in the direction of the arrows to show details of the cord anchor 422 which is illustrated in FIGS. 18 and 19.

The cord anchor 422 comprises a base 436 and an anchor ring 440. The base 436 has mid portion 444 that includes two aligned attachment holes 446 that extend through the mid portion 444. The base 436 has an anchor collar 438 at each end of the mid portion 444. Base 436 may be formed like the anchor collar 38 shown in FIGS. 5 and 6 by bending a metal strip into a square tube. A fifth side 436a may be added so that the square tube has overlapping ends as shown in FIG. 19. Side 436a has a slot 446a that aligns with the attachment holes 446. Base 436 also may be formed by drilling aligned attachment holes through a round tube and using the end portions of the tube to provide coaxial anchor collars at each end. The round tube may be continuous or split with or without overlapping ends. The anchor ring 440 is usually a D shaped ring although other shapes may be used. In any event, the anchor ring 440 preferably has a linear base that is slotted to provide two round pin portions 441 that are spaced apart for passage of a fastener through the attachment holes 446 and slot 446a. The two round pin portions 441 rotate in the coaxial anchor collars 438 respectively so that the anchor ring 440 is moveable from a storage or assembly position abutting the face plate 424 or close to it as shown in FIG. 18 to an operative position where the anchor ring 440 is at an angle with respect to the face plate 424 (not shown). The preferred operative position for anchoring an electrical cord (not shown) is best provided when the anchor ring 440 is perpendicular to the face plate 424 but an operative position where the anchor ring 440 is at a substantial angle to the face plate 424 may suffice in some instances.

The cord anchor 422 is easily attached to the electrical outlet assembly 410 which includes an electrical socket assembly 420 that like the electrical socket assembly 20 described above includes a metal strap 448 that passes through the electrical sockets 414 and lies behind the face plate 424. The single central fastener 425 which is screwed into the middle of the metal strap 448 between the electrical sockets 414 is simply removed. The base 436 of the cord anchor 422 is then held against the face plate 424 over the hole in the face plate 424 with the anchor ring 440 in an assembly position as shown in FIG. 18. The central fastener 425 then inserted through the aligned attachment holes 446 and screwed into the metal strap 448 behind the face plate 424. The cord anchor 422 will open up responsive to high pull forces downward on the anchor ring 440 due to the slot 446a which allows the pin portions 441 to unfold the anchor collars 438 releasing anchor ring 440. It may be necessary to replace the original fastener 425 with a longer fastener.

An electrical cord (not shown) is anchored and plugged into the electrical outlet assembly 410 to make a secure electrical connection either of two methods after the anchor ring 440 is raised to an operative position. In the first method, the cord plug is simply passed through the anchor ring 440 and plugged into one of the electrical sockets 414. If the cord plug is too large to pass through the anchor ring 440, the second method is used, namely, the “looping and threading” method described above in connection with FIGS. 7 and 8.

FIG. 21 is a front view of another type electrical outlet assembly 510 illustrating the cord anchor 422 described in connection with FIGS. 18, 19 and 20. The electrical outlet assembly 510 is the same type as the electrical outlet assembly 110 of the embodiment shown in FIGS. 9, 10, 13 and 14 wherein two electrical sockets 414 are embedded in a single rectangular plastic unit 420. In this type, the face plate 524 is held by upper and lower fasteners 525a and 525b.

The cord anchor 422 is easily attached to the electrical outlet assembly 510 simply by removing one of the fasteners, preferably the lower fastener 525b, screwed into the metal strap behind the face plate 524 to hold it in place. The base 436 of the cord anchor 422 is then held against the face plate 524. The removed fastener 425b, or if necessary, a longer fastener, is then inserted through the attachment holes 446 and screwed back into the metal strap behind the face plate 524.

An enhanced advantage of the cord anchor 422 when used in connection with the electrical outlet assembly 510 is that the face plate 524 is held in place by one of the fasteners 425a or 425b during the assembly process assuring that the components in the electrical box 512 behind the face plate 524 are not exposed. This enhanced advantage is available frequently because modern electrical outlet assemblies are of the type shown in FIG. 21.

When the face plate 524 is held by two fasteners as in the case of face plate 524, it is also possible to attach two cord anchors 422, one for each of the electrical outlets 414 although one cord anchor may be able to hold more than one cord depending on the size of the cords.

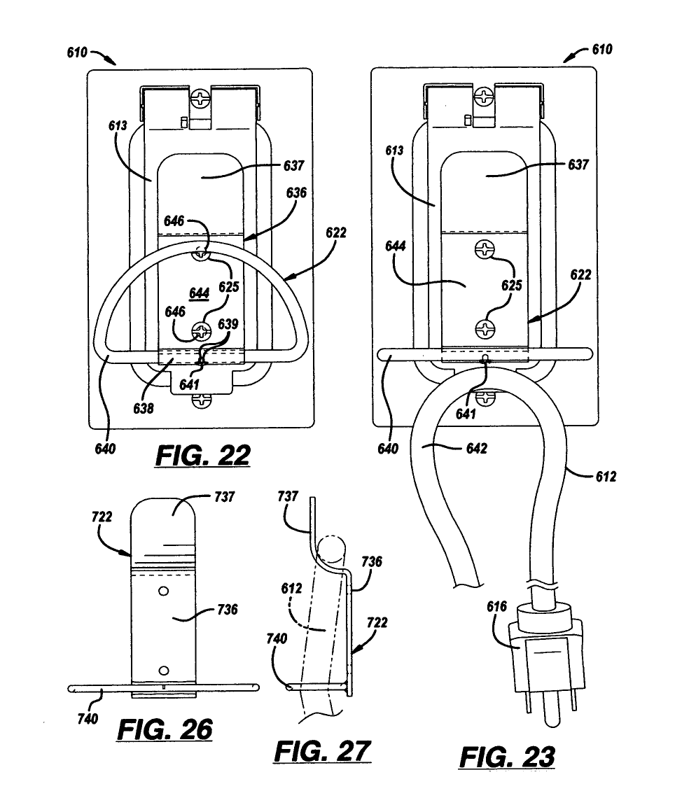

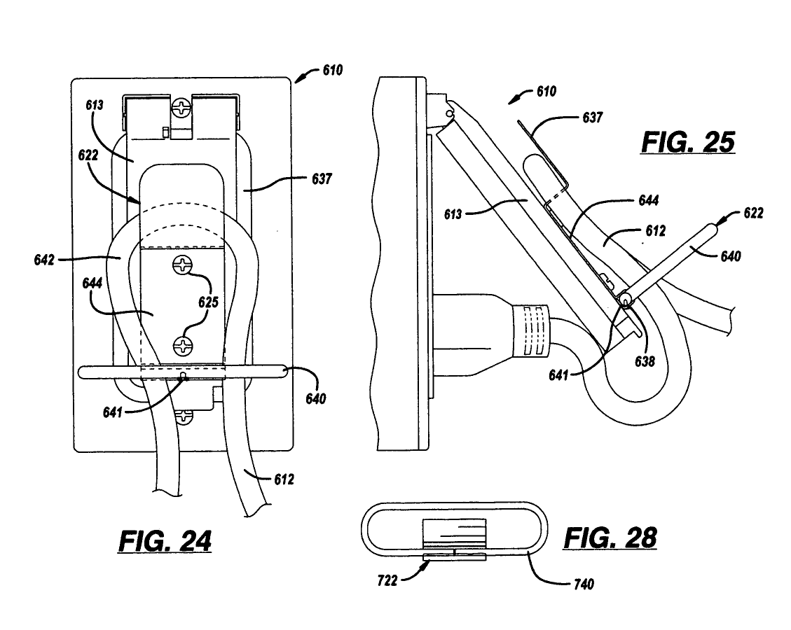

FIG. 22 is a front view an outdoor electrical outlet assembly 610 illustrating still yet another preferred embodiment of the invention; FIG. 23 is a front view of the outdoor electrical outlet assembly 610 and an electrical cord 612 in the process of being anchored to the outdoor electrical outlet assembly; FIGS. 24 and 25 are front and side views respectively of the outdoor electrical outlet assembly 610 with the electrical cord 612 anchored and connected to the electrical outlet assembly.

The cord anchor 622 for the outdoor electrical outlet assembly 610 comprises a base 636 and an anchor ring 640. The base 636 has flat end portion 644 that includes two attachment holes 646 that extend through the flat end portion 644 for attaching the cord anchor 622 to the cover door 613 of the outdoor electrical outlet assembly 610. The base 636 includes a wide hook 637 at one end of the flat end portion 644 and an anchor collar 638 at the opposite end. Anchor collar 638 may be formed like the anchor collar 38 shown in FIGS. 5 and 6 by bending a metal strip into a square tube. A fifth side may be added so that the square tube has overlapping ends as shown in FIG. 19. Anchor collar 636 preferably includes a peripheral slot 639 midway between its ends as further explained below. Base 636 also may be formed by cutting the slot 639 in a round tube which may be continuous or split with or without overlapping ends.

The anchor ring 640 is usually a D shaped ring although other shapes may be used. In any event, the anchor ring 640 preferably has a continuous linear base that serves as a round pin 641 that rotates in the anchor collar 638. Thus the anchor ring 640 is moveable from a storage or assembly position abutting the flat end portion 644 of base 636 or close to it as shown in FIG. 22 to an operative position where the anchor ring 640 is at an angle with respect to the flat base portion 644 as shown in FIGS. 23, 24 and 25. The preferred operative position for anchoring an electrical cord is best provided when the anchor ring 640 is perpendicular to the flat base portion 644. Consequently, the cord anchor 622 may include a stop as an optional feature. This stop may be provided by a flat headed screw 641 that inserted into the slot 639 and screwed into the round pin 641 forming the base of the anchor ring 640 so that the head of the screw is projects outwardly of the anchor collar 638. The screw head then engages the cover door 613 to limit the rotation of the anchor ring 640 to about 90°. While the 90° position is preferred, an operative position where the anchor ring 40 is at a substantial angle to the base portion 644 424 may suffice in some instances.

Base 636 may be formed by bending a flat strip of metal. The cord anchor 622 is easily attached to the cover 613 of the outdoor electrical outlet assembly 610 simply by inserting fasteners 625 through the attachment holes 646 and screwing the fasteners 625 into the cover door 613 as shown in FIGS. 22, 23, 24 and 25. Using self drilling screws for the attachment is preferred.

The electrical cord 612 is anchored and plugged into the outdoor electrical outlet assembly 610 to make a secure electrical connection by a “looping and threading” method similar to “looping and threading” method described above in connection with FIGS. 7 and 8. More specifically, the anchor ring 640 is lowered to an assembly or operating position and a plug end portion of the electrical cord 612 is simply looped, i.e. formed into a loop 642 as shown in FIG. 23. The loop 642 is then threaded through the anchor ring 640 and positioned in the hook 637. The electrical plug 616 is then simply plugged into the lower one of the electrical sockets 614 as shown in FIG. 25. Any pull-out force P on the electrical cord 612 takes up slack in the electrical cord 612 until it bottoms in the hook 637 whereupon the pull-out force is resisted by the anchor ring 640 plug thus anchoring the electrical cord 612 and maintaining the electrical connection of the electrical plug 616 with the electrical socket 614. It is also possible to plug the electrical plug 616 into the electrical socket 614 first and then form the loop 642, thread the loop 642 through the anchor ring 640 and position the loop 642 in the hook 637. While it is easier to use the lower electrical socket 614, it is also possible to use the upper electrical socket.

FIG. 26 is a front view of another embodiment of a cord anchor of the invention for an outdoor electrical outlet assembly such as the outdoor electrical assembly 610 shown in FIGS. 22, 23, 24 and 25; FIG. 27 is a side view of the cord anchor shown in FIG. 26 and FIG. 28 is a bottom view of the cord anchor shown in FIGS. 26 and 27.

Cord anchor 722 is similar to cord anchor 622, the major difference being that the anchor ring 740 is welded to the base 736 at the end opposite the hook 737 in an 90° or perpendicular assembly position. The cord ring 740 has also been shaped as a race track or flat oval to reduce the projection from the base portion to which it is attached.

The cord anchors 22, 122, 122A, 122B, 222, 322, 422, 622 and 722 can be installed in multiple types of electrical outlets, and thus their use not limited to the particular installations described in the above-mentioned embodiments. It should also be noted that cord anchors 622 and 722 can be used independently of an electrical outlet due to the inclusion of the hook. Thus it can be attached to any support anywhere between the ends of the cord.

While there has been described particular embodiments of the invention, it will be obvious to those skilled in the art that various changes and modifications may be made therein without departing from the invention and, therefore it is aimed to cover all such changes as fall within the true spirit and scope of the invention. For instance while the invention has been described in connection with an electrical plug at an end of an electrical cord that mates with an electrical socket of an electrical outlet, the locations of the electrical connector can be reversed. In other words, an electrical socket can be disposed at the end of the electrical cord while the mating electrical plug can be part of the electrical outlet.

I claim:

1. A cord anchor for retaining an electrical connector at the end of an electrical cord having an electrical connector for mating with the electrical connector at the end of the electrical cord in an axial direction,
the cord anchor having a member for engaging a portion of the electrical cord for diverting tension in the electrical cord away from the axial direction.

2. The cord anchor as defined in claim 1 wherein the member comprises an element selected from the group consisting of an anchor ring, a bail, a gated anchor ring, and a hook.

3. The cord anchor as defined in claim 1 wherein the cord anchor comprises a base and the member is rotatable with respect to the base.

4. The cord anchor as defined in claim 1 wherein the cord anchor comprises a base and the member is non-rotatable with respect to the base.

5. The cord anchor as defined in claim 1 wherein the cord anchor has a member for engaging an end portion of the electrical cord in the vicinity of an electrical outlet assembly for diverting tension in the electrical cord away from the axial direction.

6. The cord anchor as defined in claim 1 further including a hook for engaging the portion of the cord.

7. A cord anchor for retaining an electrical connector at the end of an electrical cord in the vicinity of an electrical outlet assembly having an electrical connector for mating with the electrical connector at the end of the electrical cord.
the cord anchor comprising a base having at least one hole for fastening the cord anchor to an electrical outlet assembly,
the cord anchor having at least one collar attached to the base,
the cord anchor having a ring that is pivotally attached to the base by the collar so as to pivot from a stored position substantially coplanar with the base to an anchoring position that is disposed at an angle with respect to the base for receiving a portion of an electrical cord.

8. The cord anchor as defined in claim 7, wherein the base has a second hole for attaching the cord anchor to the electrical outlet assembly.

9. The cord anchor as defined in claim 8 wherein and the second hole is for attaching a face plate to the electrical outlet assembly, and the electrical connector at the end of the electrical cord is an electrical plug and the electrical connector of the electrical outlet assembly is an electrical socket.

10. An electrical connection comprising:
an electrical outlet assembly having a cord anchor ring or bail and an electrical cord having an electrical connector,
the electrical cord having a portion that is formed into a loop that passes through the cord anchor ring or bail.

11. The electrical connection as defined in claim 10 wherein the loop is aligned with an electrical connector of the electrical outlet assembly, and
the electrical connector of the electrical cord bypasses the cord anchor ring or bail and extends through the loop of the electrical cord and mates with the electrical connector of the electrical outlet assembly.

12. The electrical connection as defined in claim 10 wherein the loop is engaged by a hook to keep the loop in a position where the loop passes through the cord anchor ring or bail.

13. The electrical connection as defined in claim 10 wherein the electrical connector of the electrical cord mates with the electrical connector of the electrical outlet assembly.

14. An electrical connection comprising:
an electrical outlet assembly having a gated cord anchor ring and an electrical cord having an electrical connector,
the electrical cord having a portion that is pushed laterally into the gated anchor ring and
the electrical connector of the electrical cord mating with an electrical connector of the electrical outlet assembly.

15. An electrical connection comprising:
an electrical outlet assembly having a cord anchor hook and an electrical cord having an electrical connector,
the electrical cord having a portion that is inserted laterally into the hook,
the electrical connector of the electrical cord mating with the electrical connector of the electrical outlet assembly.

16. A method of anchoring an electrical connection of an electrical outlet assembly to an electrical cord having an electrical connector comprising forming a portion of the electrical cord into a loop and threading the loop through a cord anchor ring or bail.

17. The method of claim 16 comprising the further steps of:
aligning the loop with an electrical connector of the electrical outlet assembly while leaving the electrical connector of the electrical cord spaced outwardly of the cord anchor ring or bail,
moving electrical connector of the electrical cord so that it bypasses the cord anchor ring or bail and extends through the loop of the electrical cord and mates with an electrical connector of the electrical outlet assembly.

18. The method of claim 16 comprising the further steps of:
disposing the loop in a hook after the loop is threaded through the cord ring or bail.

19. A method of anchoring an electrical connection of an electrical outlet assembly to an electrical cord having an electrical connector comprising:
pushing a portion of the electrical cord laterally into a gated anchor ring.

20. A method of anchoring an electrical connection of an electrical outlet assembly to an electrical cord having an electrical connector comprising:
inserting a portion of the electrical cord laterally into a hook.

21. An electrical outlet assembly comprising:
an electrical box, an electrical socket assembly that includes an electrical socket, a cord anchor, and a face plate,
the electrical box having an opening defined by a rim,
the electrical socket assembly having opposite ends attached to the rim of the electrical box by a fastener at each of the opposite ends so as to span the opening of the electrical box,
the cord anchor being attached to the rim of the electrical box by the fastener at one of the opposite ends of the electrical socket assembly, and
the face plate being attached to the electrical outlet assembly by another fastener so as to cover the rim of the electrical box and a portion of the cord anchor.

22. The electrical outlet assembly as defined in claim 30 wherein the cord anchor has a flat base disposed between the face plate and the rim of the electrical box, and a collar at one end of the flat base that is disposed outwardly of the face plate, and wherein the cord anchor has a ring or a bail attached to the collar so as to pivot from a stored position substantially coplanar with the base to an anchoring position that is disposed at an angle with respect to the face place and that extends away from the electrical box for receiving a portion of an electrical cord.

23. The electrical outlet assembly as defined in claim 30 wherein the electrical cord has a looped portion that threads through the cord anchor and aligns with the electrical socket, and wherein an electrical plug attached to an end portion of the electrical cord bypasses the cord anchor and extends through the looped portion of the electrical cord and plugs into the electrical socket.
